(19) United States
(12) Patent Application Publication
(10) Pub. No.: US 2011/0280281 A1
(43) Pub. Date: Nov. 17, 2011

(54) Temperature Sensor

(75) Inventor: Ross Kennedy, Harpenden (GB)

(73) Assignee: QHi Group Limited, Harpenden (GB)

(21) Appl. No.: 13/162,848

(22) Filed: Jun. 17, 2011

Related U.S. Application Data
(63) Continuation of application No. PCT/GB09/51719, filed on Dec. 16, 2009.

(30) Foreign Application Priority Data
Dec. 19, 2008 (GB) 0823182.1

(51) Int. Cl. G01K 7/16; G01K 7/00

(52) U.S. Cl. 374/185; 374/163; 374/E07.001; 374/E07.018

(57) ABSTRACT

Apparatus for measuring the temperature of a host electrical cable, comprising a sensor; the sensor comprising a first temperature sensing element which communicates readings representative of the temperature of the host electrical cable to a data acquisition device, and a the second temperature sensing element which communicates readings representative of ambient air temperature to a data acquisition device which translates the readings of the temperature sensing elements into a value of the rise of the temperature of the host electrical cable over the ambient air temperature.

This invention relates to sensors, and in particular to specific apparatus and methodology for detecting loose or degenerating electrical cable terminations via measuring the temperature of a host electrical cable in comparison to the adjacent ambient air temperature (the Delta T measurement).

In electrical cables, an increase in heat of the cable over the adjacent ambient air temperature is indicative of either increased/excess electrical load, or an increase in resistance at the connection point which would normally be associated with a connection where the integrity of that connection is compromised. Therefore continuous temperature monitoring of host electrical cables is necessary for detection for faults or malfunctions and to ensure protection of mission critical circuits from a power outage, which can also result in explosion and/or fire, depending on the level of power in the circuit. Loose or “poor” terminations are the most common cause of failure resulting in power outages and arc flash incidents.

A known method of temperature monitoring of electrical cable terminations/connections is to locate a thermocouple or thermistor element in an enclosure in which the electrical terminations/connections are housed, to measure the ambient air temperature of the enclosure. Usually mandatory regulations prohibit the enclosure being opened whilst circuits are energised, although this can vary according to national regulations.

The above method of temperature monitoring has a number of limitations. Ambient air temperature sensors can only measure the temperature at a given point and are therefore incapable of differentiating between height levels. It is usual for higher temperatures to occur at higher levels, and a sensor placed at a low level would not detect an overheating electrical connection at a high level. Furthermore, particularly in a large enclosure, a thermal lag will occur corresponding to the time between the temperature of an electrical connection/termination escalating to the point of failure, and the time taken for the ambient air temperature to rise sufficiently for the failure to be sensed. The thermal lag will often be too great to allow a reliable method of fault detection on multiple terminations/connections within the enclosure.

A further problem encountered with the above method of temperature monitoring is the number of factors which will vary from one enclosure to another, (e.g. size and therefore thermal lag), which render repeatability impossible. Thus each enclosure and the equipment within in it must be calibrated individually to ensure data produced is sufficiently reliable for alarm condition usage.

Another known method of monitoring the temperature of electrical cables terminations/connections involves the use of a single thermocouple to measure the actual temperature of the cable. A problem with such sensors is that only the surface temperature of the cable is detected. Furthermore, ambient air temperature influences the sensor readings. Ambient temperature can vary significantly, as a result, for example, of ventilation and local climate. Therefore although a sensor at a certain location may indicate a particular cable temperature, this temperature difference may have been influenced by the ambient air temperature, i.e. if the ambient air temperature increases in summer by 10 degrees centigrade, the cable temperature will rise correspondingly. Consequently, this method of temperature measurement may not accurately predict an unnatural rise in temperature on the cable which would be indicative of a fault. Indeed not only may it not detect a fault, it could provide a false indication of a fault i.e. if the ambient air temperature between winter/summer were a differential of say 30 degrees centigrade, the cable temperature would rise correspondingly by 30 degrees centigrade, which could result a false indication of a problem, unless the compared to the local ambient air temperature.

At present this would require two sensors at each termination, One placed on the cable, the other in local ambient air, with both signals being received and compared in a processor.

It is also known to monitor the temperature of an electrical enclosure by using a thermal imaging camera to provide a “rise over ambient” reading. However, this method provides only a “snap-shot” reading at the time of taking a measurement, for example on an annual basis. Furthermore, the measurement is usually taken externally to the enclosure which does not provide an accurate indication of the temperature of the cable terminations/connections within the enclosure.

Accordingly the present invention provides an apparatus as claimed in claim 1 of the appended claims.

The present invention provides a sensor apparatus for continuous monitoring of Delta T (rise in temperature of the host electrical cable over ambient temperature) of a host electrical cable adjacent to a termination/connection, relative to the local ambient air temperature, i.e. temperature of the air in the immediate vicinity of the sensor on the host electrical cable. Therefore the present invention facilitates temperature monitoring of electrical cables without the influence of external factors such as local climate, ventilation etc.

Preferably the second temperature sensing element is connected in series with the two resistors. The resistors provide that the curve of the graph of Delta T values is amplified compared to the curve which would be generated without the resistors. The accuracy of the Delta T readings is thereby enhanced, and therefore even small values of Delta T can be detected accurately, enabling earlier detection of potential faults. The resistors also eliminate the need for amplification of the sensor, therefore eliminating potential errors, drift, and re-calibration requirements.

The present invention may provide that the value of rise of the temperature of the host electrical cable over the temperature of the ambient air is compared to a predetermined value, such that when the value of the rise of the temperature of the host electrical cable over the temperature of ambient air rises over the predetermined value, an alarm is activated, to allow appropriate action to be taken.

Preferably the sensor does not include an external power source. Accordingly the sensors contain only passive components; there are no active components which provide periodic recalibration, thereby providing a significant cost saving.

Preferably all parts of the sensor apparatus are made of non electrically conductive materials and are able to operate up to an ambient temperature of 100 degrees centigrade.

An embodiment of the present invention will now be described by way of example and with reference to the accompanying drawings in which:

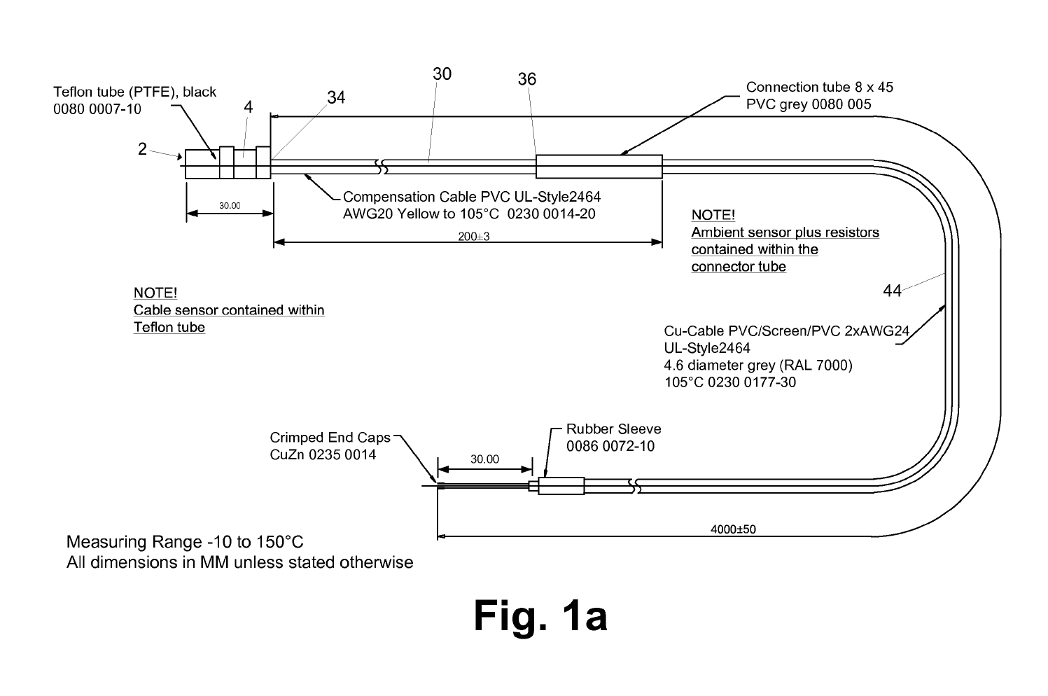

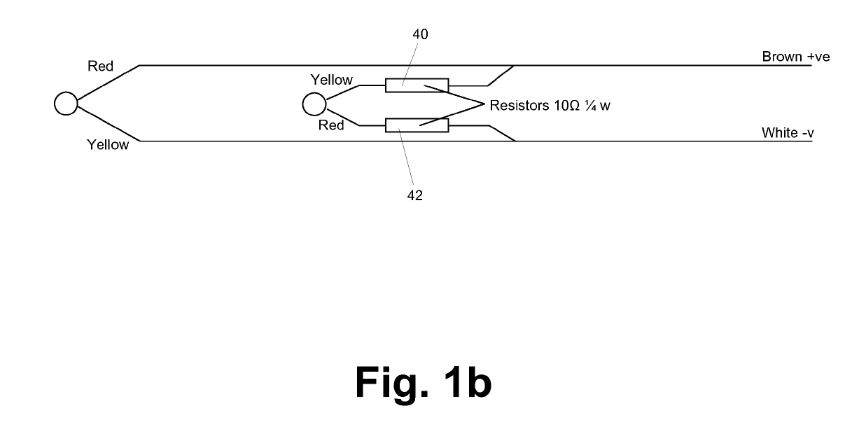

FIG. 1a is a schematic representation of an apparatus in accordance with the present invention;

FIG. 1b is a circuit diagram for the sensor the apparatus of FIG. 1b;

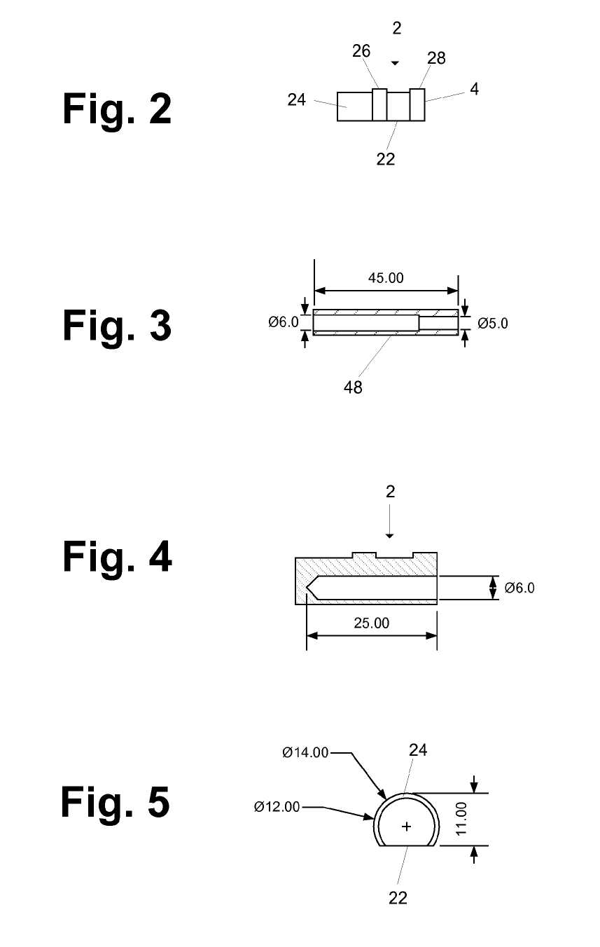

FIG. 2 is a side elevation of the sensor of FIG. 1b;

FIG. 3 is a longitudinal cross sectional view of the sensor of FIG. 2;

FIG. 4 is a longitudinal cross sectional view of the connection cylinder of the apparatus of FIG. 1b;

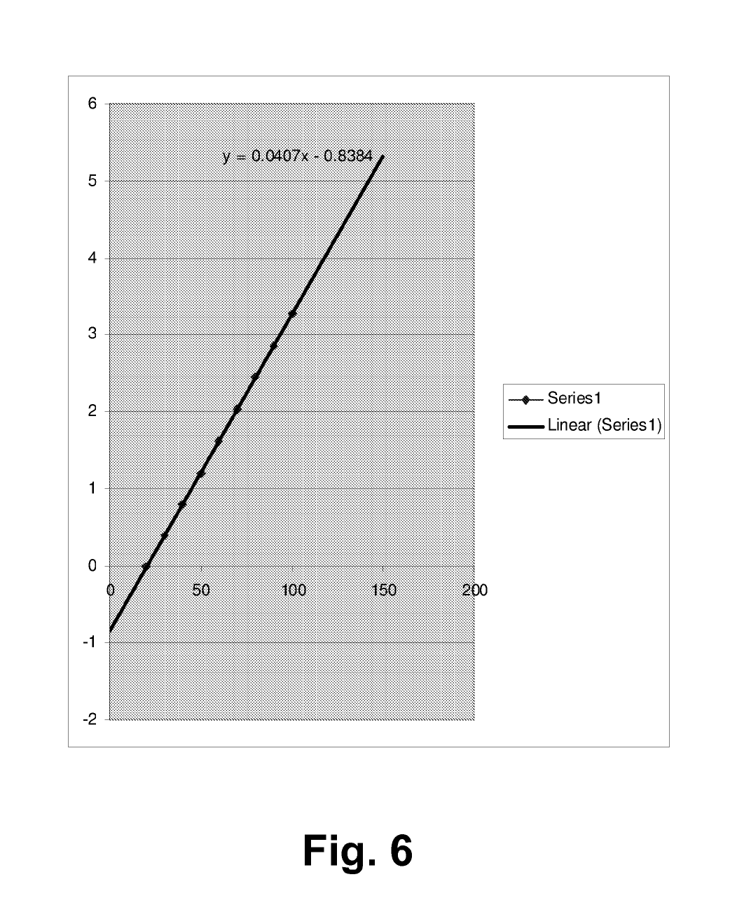

FIG. 5 is an end elevation of the sensor of FIG. 1b;

FIG. 6 is a data curve for use in a data acquisition device in accordance with the present invention; and

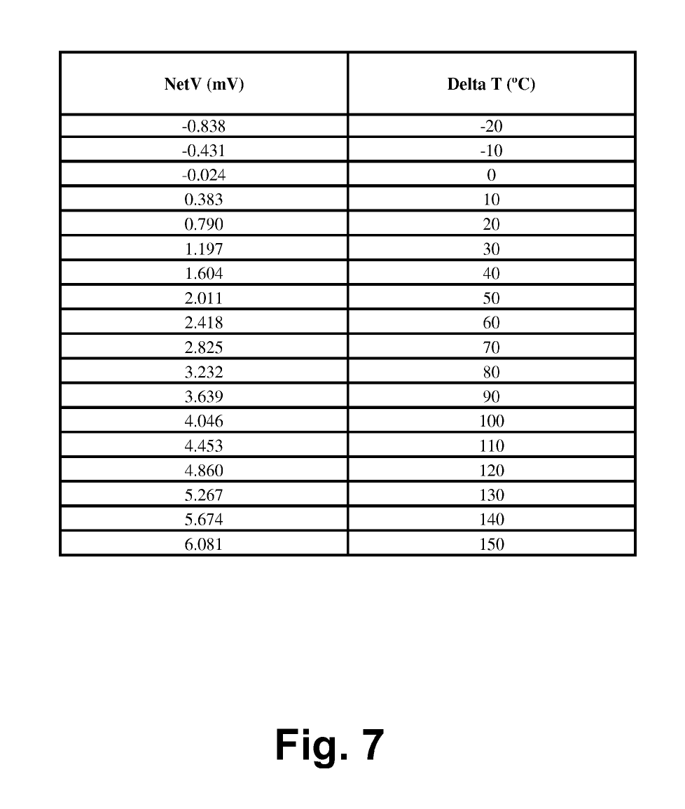

FIG. 7 is a table of values from the data curve of FIG. 5.

FIGS. 1a and 1b illustrates an apparatus a comprising a sensor 2, mounted on a host electrical cable (not shown). The sensor 2 comprises a tube 4 formed of a non-combustible material such as Teflon®. The tube 4 is provided with a flat side 22 and a ridged side 24. The ridged side 24 comprises two ridges 26, 28 which have been machined down to the relevant dimensions, e.g. 12 mm. The sensor 2 is mounted to the host electrical cable such that the flat side 22 is in contact with the host electrical cable, and is maintained in position by a cable tie (not shown).

A first temperature sensing element (not shown) is connected to a first end 34 of a thermocouple cable 30. On assembly of the sensor 2, the first temperature sensing element is inserted into the tube 4. The first temperature sensing element is then fixed into the tube 4 by epoxy resin which is inserted into the tube 4 via a syringe to prevent formation of air bubbles within the epoxy resin. The epoxy resin is left to harden to form an airtight seal.

If a load or fault causes the host electrical cable to become heated, heat from the host electrical cable is conducted through the tube 4 and the epoxy resin to the first temperature sensing element, or vice versa. Therefore changes in temperature of the host electrical cable will be detected by the first temperature sensing element. The epoxy resin allows changes of temperature of the host electrical cable to be transmitted to the first temperature sensing element without interference from ambient air, therefore providing for efficient thermal exchange, and accordingly more accurate temperature readings.

The thermocouple cable 30 is of sufficient length so as to ensure that a second end 36 of the thermocouple cable 30 is not in contact with the host electrical cable, and the that the second end 36 of the thermocouple is open to ambient air. A second temperature sensing element (not shown) is connected to the second end 36 of the thermocouple cable 30. The second temperature sensing element is connected with two 10 ohm resistors, 40, 42, in series on each side of the sensor 2.

The second temperature sensing element is connected to a copper cable 44 at a connection point 46. The second temperature sensing element is connected in a reverse polarity to the first temperature sensing element. The connection point 46 is surrounded by a cylinder 48 formed of a non-conductive material, which is filled with epoxy resin via a syringe to prevent formation of air bubbles within the cylinder. The epoxy resin is then left to harden to provide an airtight seal.

The readings of the sensor 2, are communicated to a data acquisition device (not shown), via the copper cable 44, which is connected at one end to the data acquisition device (which may be single or multi-channel). The readings of the sensor 2 comprise readings, from the first temperature sensing element which are representative of the temperature of the host electrical cable, and readings from the second temperature sensing element, which are indicative of the temperature of the ambient air.

The data acquisition device is Din rail mountable and is powered from an appropriate DC voltage supply (e.g. with a range of 10 to 36 v). The device converts the readings, which are communicated from the sensor 2 in millivolts (mV), to an industry standard protocol for electrical metering and monitoring, such as Modbus. The data acquisition device can also convert the readings of the sensor 2 into a format suitable for onward transmission into SCADA or BMS systems, via RS232, RS485 2 or 4 core system or Ethernet connection.

The polarity reversal of the first temperature sensing element and the second temperature sensing element allows a value of Delta T, i.e. a value of ‘temperature rise over ambient’, to be calculated by the data acquisition device from the sensor 2. When the first temperature sensing element and the second temperature sensing element are at the same temperature, one element would communicate a positive value reading to the data acquisition device, the other element would communicate a negative value reading to the data acquisition device. For example, if the first temperature sensing element communicates a reading representative of the temperature of the host electrical cable of 0.790 mV, and the second temperature sensing element communicates a reading representative of the temperature of the ambient air of 0.814 mV after passing through the two resistors, the resulting value calculated by the data acquisition device, NetV would be the net value of the two readings, i.e. +0.790+−0.814, resulting in a NetV value of −0.024 mV. This reading is then converted by the data acquisition device into a value of Delta T, using the relevant data curve for the particular sensor, which has pre-programmed into the device. The values of Delta T are then stored in a register within the data acquisition device.

The data acquisition device is accorded a unique address, which allows it to be incorporated within a network of devices. The network may comprise identical or different data acquisition devices which incorporate the same protocol and communications parameters.

FIG. 5 is an example of a data curve used by the data acquisition device to convert NetV values, in mV, into Delta T values, in ° C., based on laboratory water bath testing of the apparatus. FIG. 6 is a conversion table of values of the graph of FIG. 6, at 10° C. intervals. In the example provided above, using the conversion table of FIG. 6, the above readings would be converted into a 0° C. rise over ambient value.

In the present example, the readings of the first and second temperature sensing elements are initially different from one another. If an electrical fault caused the temperature of the host electrical cable to rise, and the reading of the second temperature sensing element to rise accordingly, and the reading of the first temperature sensing element remained at 0.790 mV, and the data acquisition device calculated a NetV value of 1.604 mV, this value would be converted, in accordance with the table of FIG. 5, into a Delta T value, i.e. a rise over ambient, of 40° C.

The values of Delta T which have been calculated by the data acquisition device are translated into a graph. The resistors 40, 42, provide that the curve of the graph is amplified compared to the curve which would be generated without the resistors, therefore providing a greater accuracy of temperature readings than if the temperature sensing elements were to be used alone, which is of particular importance if the temperature changes are small. Earlier detection of potential faults is therefore enabled. The resistors 40, 42, also eliminate the need for amplification of the sensor, therefore eliminating potential errors, drift, and re-calibration requirements.

The data acquisition device compares the calculated values of Delta T to a predetermined temperature value which is likely to be indicative of a fault or malfunction. If a Delta T value exceeds the predetermined value, a alarm will be activated to indicate the likely fault or malfunction, to enable appropriate action to be taken.

All parts of the sensor apparatus are made of non electrically conductive materials and are able to operate up to an ambient temperature of 100 degrees centigrade.

The embodiment of the sensor 2 described above includes only passive components, and therefore is not capable of storing any energy, and does not require a power supply (the only power supply required is a DC power supply for the data acquisition device).

1. Apparatus for measuring the temperature of a host electrical cable, comprising a sensor and a data acquisition device,
the sensor comprising a first temperature sensing element and a second temperature sensing element,
wherein the first temperature sensing element communicates readings representative of the temperature of the host electrical cable to a data acquisition device, and the second temperature sensing element communicates readings representative of the temperature of the ambient air to the data acquisition device,
and wherein the data acquisition device translates the readings of the first and second temperature sensing elements into a value of the rise of the temperature of the host electrical cable over the temperature of the ambient air.

2. An apparatus as claimed in claimed in claim 1, which includes two resistors arranged in series, wherein the second temperature sensing element is connected in series with two resistors.

3. Apparatus as claimed in claim 1, wherein the temperature of the host electrical cable is continuously measured.

4. An apparatus as claimed in claimed in claim 3, which includes two resistors arranged in series, wherein the second temperature sensing element is connected in series with two resistors.

5. An apparatus as claimed in claim 1, wherein the value of rise of the temperature of the host electrical cable over the temperature of the ambient air is continuously compared to a predetermined value, wherein when the value of the rise of the temperature of the host electrical cable over the temperature of ambient air rises over the predetermined value, an alarm is activated.

6. An apparatus as claimed in claim 1, wherein the sensor includes only passive components.
